(19) United States
(12) Patent Application Publication
(10) Pub. No.: US 2018/0156316 A1
(43) Pub. Date: Jun. 7, 2018

(54) CONTROL SYSTEM FOR ENGAGEMENT DEVICE

(71) Applicants: TOYOTA JIDOSHA KABUSHIKI KAISHA, Toyota-shi (JP); Kabushiki Kaisha Toyota Chuo Kenkyusho, Nagakute-shi (JP)

(72) Inventors: Hidekazu NAGAI, Susono-shi (JP); Kensei HATA, Shizuoka-ken (JP); Takahito ENDO, Shizuoka-ken (JP); Akira MURAKAMI, Gotemba-shi (JP); Yoshihiro MIZUNO, Nagakute-shi (JP); Eiji TSUCHIYA, Nagakute-shi (JP); Norio YONEZAWA, Nagakute-shi (JP)

(73) Assignees: TOYOTA JIDOSHA KABUSHIKI KAISHA, Toyota-shi (JP); Kabushiki Kaisha Toyota Chuo Kenkyusho, Nagakute-shi (JP)

(21) Appl. No.: 15/827,889

(22) Filed: Nov. 30, 2017

(30) Foreign Application Priority Data
Dec. 2, 2016 (JP) 2016-235276

(51) Int. Cl. F16H 3/78; F16H 3/72; B60K 6/365

(52) U.S. Cl. CPC F16H 3/78; F16H 2716/08; B60K 6/365; F16H 3/727

(57) ABSTRACT

A control system for an engagement device that engage the engagement device promptly to reduce a power loss is provided. The control system has a controller configured to start controlling a first motor in such a manner as to synchronize a rotational speed of a first engagement element to a rotational speed of a second engagement element, simultaneously with a commencement of engagement of the first engagement element with the second engagement element, or after the commencement of the engagement of the first engagement element with the second engagement element.

### CROSS REFERENCE TO RELATED APPLICATIONS

The present invention claims the benefit of priority to Japanese Patent Application No. 2016-235276 filed on Dec. 2, 2016 with the Japanese Patent Office, the entire contents of which are incorporated herein by reference in its entirety.

### BACKGROUND

### Field of the Invention

Embodiments of the present disclosure relates to the art of a control system for an engagement device used in a powertrain of a vehicle.

### Discussion of the Related Art

JP-A-2009-154622 describes a control system for a hybrid vehicle having an engine, a first electric motor, and a second electric motor. According to the teachings of JP-A-2009-154622, the control system is configured to shift a speed change mode between a continuously variable mode in which an engine speed is varied continuously and a stepwise mode in which an engine speed is varied stepwise by manipulating engagement devices such as a clutch and a brake.

Publication of Japanese patent JP-B-2701321 describes an electromagnetic brake adapted to cut electric power consumption. The electromagnetic brake taught by JP-B-2701321 is actuated by applying a transient pulse current to a coil so as to reverse the polarity of one of two permanent magnets. Specifically, the electromagnetic brake is frictionally engaged by magnetically attracting an armature.

The engagement devices such as the clutch and the brake taught by JP-A-2009-154622 and JP-B-2701321 are actuated hydraulically or electromagnetically. In order to reduce engagement shock and to limit damage, according to the prior art, the conventional engagement device is brought into engagement while synchronizing rotational speeds of rotary elements.

However, if the engagement device is engaged after synchronization of rotational speeds as taught by JP-A-2009-154622, it may take longer time to synchronize rotational speeds of clutch plates. Consequently, an operating point of a prime mover connected to the engagement device may be shifted significantly during the synchronization of the clutch plates thereby increasing a power loss. In addition, the engagement device may not be engaged promptly.

### SUMMARY

Aspects of preferred embodiments of the present application have been conceived noting the foregoing technical problems, and it is therefore an object of the present application is to provide a control system for an engagement device configured to engage the engagement device promptly thereby reducing a power loss resulting from synchronization of rotational speeds and maintaining balance between power generation and power consumption.

The control system according to the embodiment of the present disclosure is applied to an engagement device, comprising: a first engagement element and a second engagement element allowed to rotate relatively to each other; a first motor that applies torque to the first engagement element to synchronize a rotational speed of the first engagement element to a rotational speed of the second engagement element; a magnetic force generating member that is arranged in one of the first engagement element and the second engagement element to generate magnetic attraction to integrate the first engagement element with the second engagement element in a rotational direction while keeping a gap therebetween. The control system comprises a controller that is configured to: selectively engage the first engagement element with the second engagement element by selectively generates the magnetic attraction by the magnetic force generating member; and start controlling the first motor in such a manner as to synchronize a rotational speed of the first engagement element to a rotational speed of the second engagement element simultaneously with a commencement of engagement of the first engagement element with the second engagement element, or after the commencement of the engagement of the first engagement element with the second engagement element.

In a non-limiting embodiment, the first engagement element may include an outer circumferential face, and the second engagement element may include an inner circumferential face opposed to the outer circumferential face of the first engagement element. A plurality of protrusions may be formed on the outer circumferential face of the first engagement element in such a manner as to protrude toward the inner circumferential face of the second engagement element, and a plurality of protrusions may be formed on the inner circumferential face of the second engagement element in such a manner as to protrude toward the outer circumferential face of the first engagement element.

In a non-limiting embodiment, the magnetic force generating member may include a first permanent magnet, and a second permanent magnet arranged in the second engagement element. A polarity of the second permanent magnet may be set in such a manner as to establish a closed magnetic circuit within the second engagement element between the first permanent magnet and the second permanent magnet. The magnetic force generating member may further include a switching member that is arranged around the second permanent magnet to switch the polarity of the second permanent magnet. The first engagement element may be formed of magnetic material at least partially to be magnetically attracted toward the second engagement element. In addition, the controller may be further configured to disengage the first engagement element from the second engagement element by controlling the switching member to establish the closed magnetic circuit within the second engagement element, and engage the first engagement element with the second engagement element by controlling the switching member to generate the magnetic attraction between first engagement element and the second engagement element.

In a non-limiting embodiment, the switching member may include a coil wound around the second permanent magnet, and the polarity of the second permanent magnet may be reversed by applying current to the coil.

In a non-limiting embodiment, the controller may be further configured to reduce an output torque of the first motor to zero, if a difference between a rotational speed of the first engagement element and a rotational speed of the second engagement element is smaller than a first threshold value during the synchronization of the rotational speed of the first engagement element to the rotational speed of the second engagement element.

In a non-limiting embodiment, the controller may be further configured to determine completion of engagement of the first engagement element with the second engagement element, when a difference between the rotational speed of the first engagement element and the rotational speed of the second engagement element is reduced smaller than a second threshold value by reducing the output torque of the first motor to zero during the synchronization of the rotational speed of the first engagement element to the rotational speed of the second engagement element.

In a non-limiting embodiment, the engagement element may be applied to a vehicle in which a prime mover includes the engine, the first motor, and a second motor, and the vehicle may include a differential mechanism that performs a differential action among a first rotary element, a second rotary element, and a third rotary element. The first motor may be connected to the first rotary element, the engine may be connected to the second rotary element, and an output member may be connected to the third rotary element to deliver torque to drive wheels. The second motor may be connected to a power transmission route between the drive wheels and the third rotary element, and the second motor may be operated by electricity generated by the first motor to generate torque delivered to the drive wheels.

In a non-limiting embodiment, the differential mechanism may include: a first differential mechanism that performs a differential action among the first rotary element, the second rotary element, and the third rotary element; and a second differential mechanism that performs a differential action among a fourth rotary element, a fifth rotary element connected to the engine, and a sixth rotary element connected to the first motor.

Thus, in the engagement device according to the embodiment of the present disclosure, one of the engagement elements generates the magnetic attraction to attract the other engagement element so that the engagement elements are engaged to each other while keeping a predetermined gap therebetween. In addition, the controller is configured to start controlling the first motor in such a manner as to synchronize a rotational speed of the first engagement element to the second engagement element, simultaneously with a commencement of engagement of the first engagement element with the second engagement element, or after the commencement of the engagement of the first engagement element with the second engagement element. According to the embodiment of the present disclosure, therefore, the required time from the commencement of the speed reduction of the first motor to the completion of the engagement of the engagement device may be reduced. That is, the engagement device may be engaged promptly. In addition, a power loss resulting from the speed reduction of the first motor may be reduced.

In the engagement device, the protrusions serving as magnetic poles are opposed to each other to form a salient pole structure so that the magnetic attraction acting between the first engagement element and the second engagement element is enhanced. According to the embodiment of the present disclosure, therefore, the engagement device may be engaged more promptly.

As described, the controller reduces an output torque of the first motor to zero, when a difference between a rotational speed of the first engagement element and a rotational speed of the second engagement element is reduced smaller than the first threshold value during the synchronization of the rotational speed of the first engagement element to the rotational speed of the second engagement element. In this situation, said other engagement element magnetically attracted to said one of the engagement element is free from the torque of the first motor so that the engagement elements are engaged to each other promptly without delay.

In addition, since the required time of the speed reduction of the first motor is reduced, an operating point of the first motor will not be shifted significantly. For this reason, a generating amount of the first motor will not be changed significantly and hence electric supply to the second motor may be stabilized.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a schematic illustration showing a first example of a powertrain of the vehicle to which the control system according to the embodiment of the present application is applied;

FIGS. 2A and 2B are schematic illustrations showing a magnetic field in the engagement device, in which FIG. 2A shows the engagement device in disengagement and FIG. 2B shows the engagement device in engagement;

FIGS. 3A and 3B are schematic illustrations showing the engagement device, in which FIG. 3A shows the engagement device in disengagement, and FIG. 3B shows the engagement device in engagement;

FIG. 4 is a schematic illustration showing a salient pole structure of the engagement device shown in FIGS. 3A and 3B;

FIG. 5 is a flowchart showing an example of a routine executed by the control system according to the embodiment of present disclosure;

FIGS. 6A and 6B are schematic illustrations showing speed reduction torque and magnetic attraction applied to the engagement device, in which FIG. 6A shows a situation where a speed difference between the engagement element is greater than a predetermined value, and FIG. 6B shows a situation where a speed difference between the engagement element is smaller than a predetermined value;

FIG. 7 is a graph showing a speed difference between the engagement elements and a condition of the first motor;

FIG. 8 is a flowchart showing another example of a routine executed by the control system according to the embodiment of present disclosure;

FIG. 9 is a schematic illustration showing a second example of the powertrain of the vehicle to which the control system according to the embodiment of the present application is applied; and

FIG. 10 is a schematic illustration showing a third example of the powertrain of the vehicle to which the control system according to the embodiment of the present application is applied.

### DETAILED DESCRIPTION OF THE PREFERRED EMBODIMENT(S)

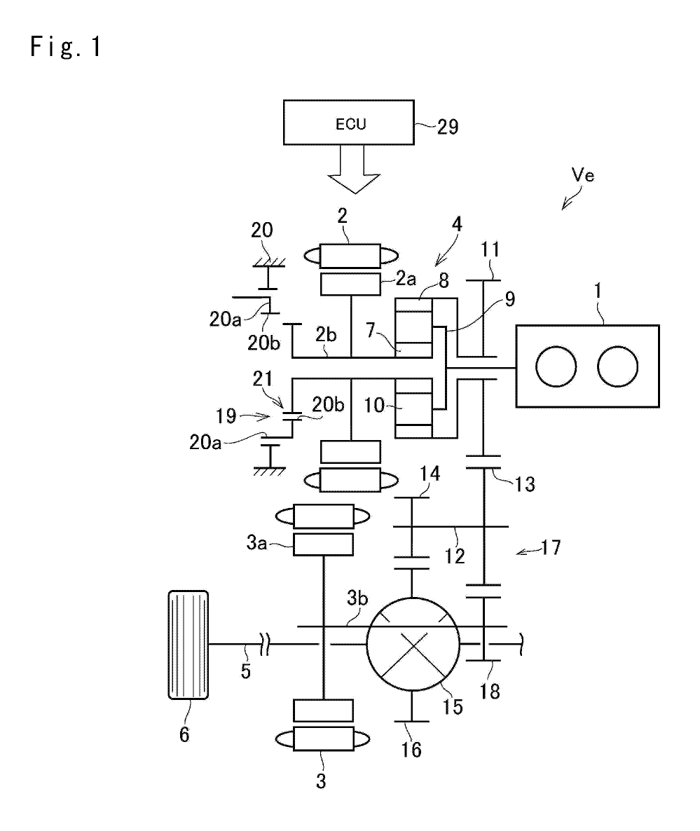

Embodiment of the present disclosure will now be explained with reference to the accompanying drawings. Referring now to FIG. 1, there is shown a first example of a powertrain of a vehicle Ve to which the control system according to the embodiment is applied. A prime mover of the vehicle Ve includes an engine 1 as a main prime mover, a first motor 2, and a second motor 3. An output power of the engine 1 is distributed to the first motor 2 and to a driveshaft 5 through a power split device 4 as a differential mechanism. An electric power generated by the first motor 2 may be supplied to the second motor 3 to generate torque, and output torque of the second motor 3 may be delivered to drive wheels 6 through the driveshaft 5.

Each of the first motor 2 and the second motor 3 is a motor-generator that is operated not only as a motor to generate torque by applying electricity thereto, but also as a generator to generate electricity by applying torque thereto. For example, a permanent magnet synchronous motor and an AC motor such as an induction motor may be used as the first motor 2 and the second motor 3. The first motor 2 and the second motor 3 are connected to a storage device such as a battery and a capacitor through an inverter (neither of which are shown) so that electric power may be supplied to the first motor 2 and the second motor 3 from the storage device. The storage device may also be charged with electric power generated by the first motor 2 and the second motor 3.

The power split device 4 as a single-pinion planetary gear unit is connected to an output shaft of the engine 1 to distribute output power of the engine 1 to the first motor 2 and to the drive wheels 6. The power split device 4 comprises a sun gear 7 as a first rotary element, a ring gear 8 as a third rotary element arranged concentrically with the sun gear 7, a plurality of pinion gears 10 interposed between the sun gear 7 and the ring gear 8, and a carrier 9 as a second rotary element supporting the pinion gears 10 in a rotatable manner.

In the power split device 4, the carrier 9 is connected to the output shaft of the engine 1. That is, the output shaft of the engine 1 also serves as an input shaft of the power split device 4.

The first motor 2 is disposed in an opposite side of the engine 1 across the power split device 4, and in the first motor 2, a hollow rotor shaft 2b that is rotated integrally with a rotor 2a is connected to the sun gear 7 of the power split device 4.

A first drive gear 11 as an external gear is formed integrally with the ring gear 8 of the power split device 4 to serve as an output member, and a countershaft 12 is arranged in parallel with a common rotational axis of the power split device 4 and the first motor 2. A counter driven gear 13 is fitted onto one end of the countershaft 12 (i.e., right side in FIG. 1) to be rotated integrally therewith while being meshed with the first drive gear 11, and a counter drive gear (i.e., a final drive gear) 14 is fitted onto the other end of the countershaft 12 (i.e., left side in FIG. 1) in such a manner as to be rotated therewith while being meshed with a differential ring gear (i.e., a final driven gear) 16 of a differential gear unit 15 as a final reduction. Thus, the ring gear 8 of the power split device 4 is connected to the driveshaft 5 and the drive wheels 6 through the first drive gear 11, the countershaft 12, the counter driven gear 13, the counter drive gear 14, and an output gear train 17 including the differential ring gear 16.

In the powertrain of the vehicle Ve, an output torque of the second motor 3 can be added to the torque delivered from the power split device 4 to the drive wheels 6 through the driveshaft 5. To this end, a rotor 3a of the second motor 3 is connected to a rotor shaft 3b extending in parallel with the countershaft 12 to rotate integrally therewith, and a second drive gear 18 is fitted onto a leading end of the rotor shaft 3b to be rotated integrally therewith while being meshed with the counter driven gear 13. Thus, the ring gear 8 of the power split device 4 and the second motor 3 are individually connected to the drive wheels 6 through the second drive gear 18, the differential gear unit 16, and the driveshaft 5.

In order to selectively stop a rotation of the first motor 2, a brake 19 as an engagement device is arranged in the powertrain of the vehicle Ve. According to the embodiment, an electromagnetic brake in which an engagement state is switched by energizing a coil is used as the brake 19. In the powertrain shown in FIG. 1, the brake 19 is disposed between the sun gear 7 and a stationary member 20 such as a casing and a housing so that a rotation of the rotor shaft 2b of the first motor 2 connected to the sun gear 7 is stopped by engaging the brake 19. Specifically, a cylindrical shaft 20a as a second engagement element is engaged with the stationary member 20, and a magnetic face is formed on an inner circumferential face 20b of the cylindrical shaft 20a. A magnetic face is also formed on an outer circumferential face 21 of a leading end of the rotor shaft 2b as a first engagement element to be opposed to the magnetic face of the cylindrical shaft 20a. Here, the magnetic face may also be attached individually to the inner circumferential face 20b of the cylindrical shaft 20a and the outer circumferential face 21 of the rotor shaft 2b.

The brake 19 may also serve as a torque limiter to avoid overload in the powertrain. That is, the brake 19 is disengaged when a torque applied thereto exceed an upper limit value even if the brake 19 is in engagement. In FIG. 1, an upper half of the cylindrical shaft 20a indicates disengagement of the brake 19, and a lower half of the cylindrical shaft 20a indicates engagement of the brake 19.

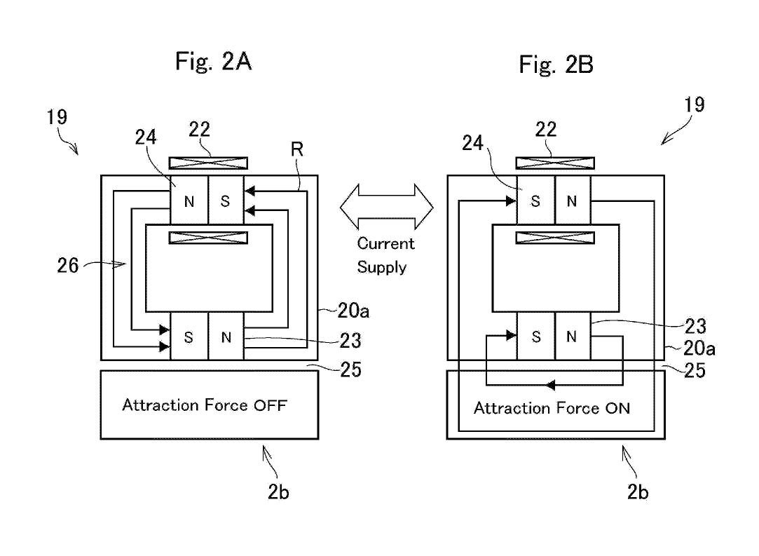

Principle for activation of the brake 19 is shown in FIGS. 2A and 2B. In the electromagnetic brake, polarity of one of magnets is reversed by applying current to a coil 22 wound around the magnet. Consequently, magnetic attraction is established so that the engagement elements are engaged to each other. That is, the brake 19 may also be called a variable field engagement device. Specifically, as illustrated in FIGS. 2A and 2B, in the brake 19, a first permanent magnet 23 is arranged in a radially outer portion of the cylindrical shaft 20a, and a second permanent magnet 24 is arranged in a radially inner portion of the cylindrical shaft 20a. For example, a neodymium magnet that can establish a stronger magnetic force may be used as the first permanent magnet 23. On the other hand, an alnico magnet may be used as the second permanent magnet 24, and the coil 22 is wound around the second permanent magnet 24. In the brake 19, the cylindrical shaft 20a and the rotor shaft 2b are engaged to each other while keeping an air gap 25 between the inner circumferential face 20b and the outer circumferential face 21 when the coil 22 is energized to switch the polarity of the second permanent magnet 24. Specifically, when direct current is applied to the coil 22, polarity of the second permanent magnet 24 is reversed to establish magnetic force applied to the rotor shaft 2b so that the inner circumferential face 20b and the outer circumferential face 21 are magnetically engaged to each other without being contacted to each other. Accordingly, the first permanent magnet 23 and the second permanent magnet 24 serve as a magnetic force generating member.

FIG. 2A shows a situation in which the brake 19 is in disengagement, and in FIG. 2A, a magnetic field is indicated by arrows. As known in the art, a magnetic flux flows only from the North pole toward the South pole. According to the embodiment, as illustrated in FIG. 2A, polarity of the second permanent magnet 24 is set in such a manner that magnetic fluxes flow only within the cylindrical shaft 20a when the brake 19 is in disengagement. In the brake 19, therefore, a closed magnetic circuit R is established within the cylindrical shaft 20a between the first permanent magnet 23 and the second permanent magnet 24 when the brake 19 is in disengagement as indicated by the arrows in FIG. 2A. In this situation, the polarity of the second permanent magnet 24 is reversed by applying current to the coil 22 as shown in FIG. 2B so that the directions of the magnetic fluxes are reversed to circulate between the first permanent magnet 23 and the second permanent magnet 24 through the rotor shaft 2b. Consequently, the rotor shaft 2b and the cylindrical shaft 20a are magnetically attracted to each other, that is, the brake 19 is brought into engagement. In this situation, the brake 19 is brought into disengagement again by applying current to the coil 22 to reverse the polarity of the second permanent magnet 24 again. Thus, the second permanent magnet 24 also serves as a switching member that reverses the polarity thereof when the coil 22 is energized. Although the brake 19 in which the cylindrical shaft 20a is fixed to the stationary member 20 such as a casing is used in the power train of the vehicle Ve, an electromagnetic clutch in which a pair of engagement elements is allowed to rotate relatively may also be used in the power train of the vehicle Ve.

Thus, the brake 19 may be activated without requiring hydraulic pressure, and may be maintained in engagement without supplying current thereto. In addition, since the engagement elements are engaged while maintaining a clearance therebetween, the brake 19 may be prevented from being frictionally damaged without requiring lubrication. Further, the above-mentioned upper limit torque may be altered arbitrarily by varying a current value applied to the coil 22.

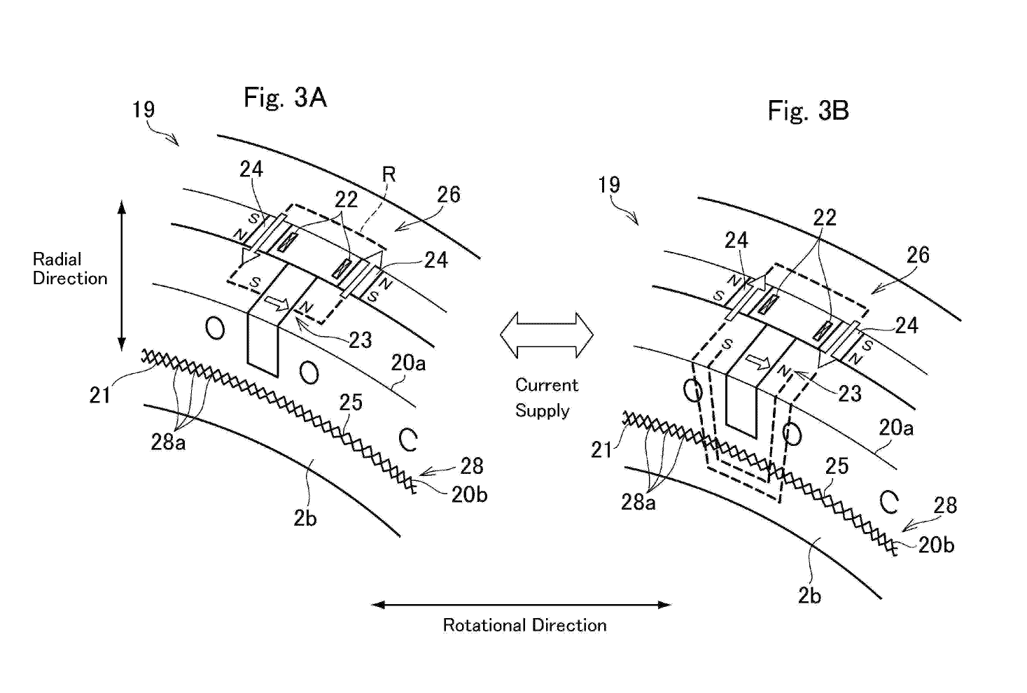

Structure of the brake 19 is depicted in FIGS. 3A and 3B in more detail. Specifically, FIG. 3A shows a situation in which the brake 19 is in disengagement, and FIG. 3B shows a situation in which the brake 19 is in engagement. As illustrated in FIGS. 3A and 3B, in the cylindrical shaft 20a, a pair of the second permanent magnets 24 is arranged in a circumferential direction, and the first permanent magnet 23 is arranged between the second permanent magnets 24 in the normal direction. As described, the inner circumferential face 20b of the cylindrical shaft 20a and the outer circumferential face 21 of the rotor shaft 2b are magnetically engaged to each other while maintaining the air gap 25. Specifically, the air gap 25 is set as narrow as possible to increase magnetic density thereby generating strong magnetic force, but a sufficient clearance is still maintained between the inner circumferential face 20b of the cylindrical shaft 20a and the outer circumferential face 21 of the rotor shaft 2b to avoid undesirable contact between those faces even if the engine 1 generates vibrations. Here, number of sets of the first permanent magnet 23 and the second permanent magnets 24 may be altered arbitrarily according to need.

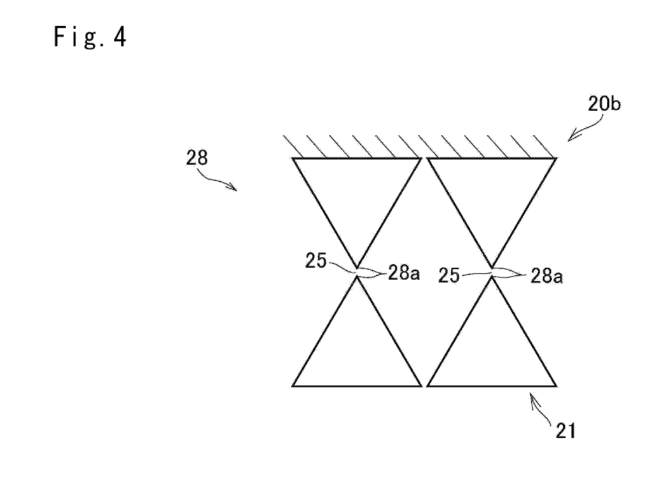

As depicted in FIG. 4, the inner circumferential face 20b of the cylindrical shaft 20a and the outer circumferential face 21 of the rotor shaft 2b form a salient pole structure 28. Specifically, a plurality of protrusions 28a individually having a triangle cross-section are formed on the inner circumferential face 20b of the cylindrical shaft 20a and the outer circumferential face 21 of the rotor shaft 2b. In the inner circumferential face 20b of the cylindrical shaft 20a, each of the protrusions 28a is tapered toward the outer circumferential face 21 of the rotor shaft 2b. On the other hand, in the outer circumferential face 21 of the rotor shaft 2b, each of the protrusions 28a is tapered toward the inner circumferential face 20b of the cylindrical shaft 20a. In the brake 19, the magnetic attraction acting between the inner circumferential face 20b of the cylindrical shaft 20a and the outer circumferential face 21 of the rotor shaft 2b is varied depending on a relative position between leading ends of the protrusions 28a of the inner circumferential face 20b and the outer circumferential face 21. Specifically, the magnetic attraction becomes strongest when the leading ends of the protrusions 28a of the inner circumferential face 20b and the outer circumferential face 21 are opposed to each other, so that the cylindrical shaft 20a and the rotor shaft 2b are engaged to each other while maintaining the air gap 25 therebetween. However, the magnetic attraction still acts between the inner circumferential face 20b and the outer circumferential face 21 even when the leading ends of the protrusions 28a of one of the inner circumferential face 20b and the outer circumferential face 21 is displaced from the leading ends of the other one of the inner circumferential face 20b and the outer circumferential face 21. Here, shape of the protrusion 28a may be altered e.g., to have a truncated trapezoidal cross-section.

As indicated in FIG. 3A, when the brake 19 is in disengagement, the polarity of the second permanent magnet 24 is set in such a manner as to establish the closed magnetic circuit R within the cylindrical shaft 20a between the first permanent magnet 23 and the second permanent magnet 24. In this situation, the polarity of the second permanent magnet 24 is reversed by applying current to the coil 22 as shown in FIG. 3B so that the directions of the magnetic fluxes are reversed to circulate between the first permanent magnet 23 and the second permanent magnet 24 through the rotor shaft 2b. Consequently, the rotor shaft 2b and the cylindrical shaft 20a are magnetically attracted to each other so that the brake 19 is brought into engagement to stop the rotation of the rotor shaft 2b of the first motor 2 connected to the sun gear 7 of the power split device 4.

An operating mode of the vehicle Ve may be selected from a hybrid mode (to be abbreviated as the “HV mode” hereinafter) in which the vehicle Ve is powered by the engine 1, and an electric vehicle mode in which the vehicle Ve is powered by the first motor 2 and the second motor 3 while supplying electric power to the motors 2 and 3 from the storage device. The operating mode of the vehicle Ve, the engine 1, the first motor 2, the second motor 3, the brake 19 and so on are controlled by an electronic control unit (to be abbreviated as the “ECU” hereinafter) 29 shown in FIG. 1 as a controller. The ECU 20 is composed mainly of a microcomputer configured to carry out a calculation based on incident data, stored data and stored programs, and transmit a calculation result in the form of command signal. For example, a vehicle speed, a wheel speed, a position of an accelerator pedal, a state of charge (to be abbreviated as the “SOC” hereinafter) of the storage device, a speed and an output torque of the engine 1, speeds and output torques of the motors 2 and 3, an engagement state of the brake 19 and so on are sent to the ECU 29, and maps determining the operating mode and so on are installed in the ECU 29. Specifically, the ECU 29 transmits command signals for starting and stopping the engine 1, torque command signals for operating the engine 1, the first motor 2, and the second motor 3 and so on. Optionally, a plurality of the ECUs may be arranged in the vehicle Ve according to need.

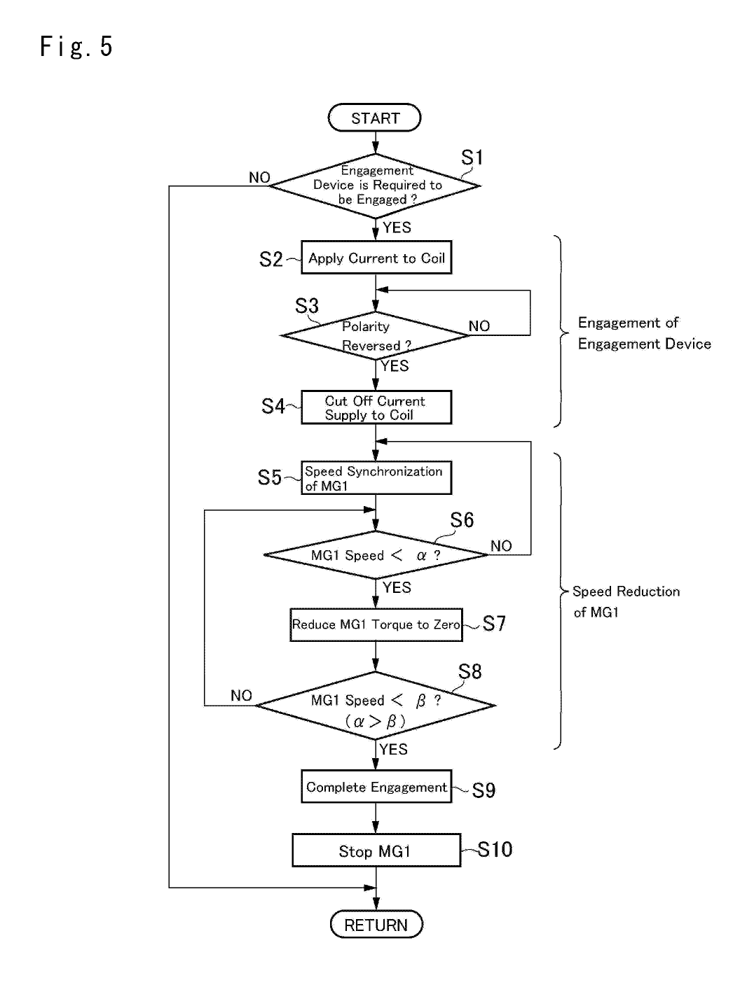

As described, the brake 19 as an electromagnetic engagement device is advantageous to reduce electrical consumption and to limit damage on the engagement elements. However, if the brake 19 is engaged to stop the rotation of the rotor shaft 2b of the first motor 2 without controlling a speed of the first motor 2, an operating point of the first motor 2 may be shifted significantly. Consequently, a power loss of the first motor 2 may be increased, and power generation and power consumption of the first motor 2 may be unbalanced. In order to engage the brake 19 promptly thereby reducing a power loss and maintaining balance between power generation of the first motor 2 and power consumption of the second motor 3, the ECU 29 is configured to execute the routine shown in FIG. 5.

The routine shown in FIG. 5 is started when the brake 19 is in disengagement.

At step S1, it is determined whether or not the brake 19 is required to be engaged. As described, when the brake 19 is in disengagement, the closed magnetic circuit R is established within the cylindrical shaft 20a between the first permanent magnet 23 and the second permanent magnet 24 and hence the rotor shaft 2b and the cylindrical shaft 20a are not magnetically attracted to each other. For example, the brake 19 is required to be engaged when shifting the operating mode from the HV mode in which the vehicle Ve is powered by the engine 1 and the first motor 2 to an engine mode in which the vehicle Ve is powered only by the engine 1 while stopping the rotation of the first motor 2. In addition, the brake 19 is also required to be engaged to stop the rotation of the first motor 2 when the first motor 2 has to be cooled and when the first motor 2 has to be protected.

If the brake 19 is not required to be engaged so that the answer of step S1 is NO, the routine returns. By contrast, if the brake 19 is required to be engaged so that the answer of step S1 is YES, the routine progresses to step S2 to apply current to the coil 22 so as to reverse the polarity of the second permanent magnet 24.

At step S2, specifically, direct current is applied to the coil 22 to establish the magnetic attrition to engage the brake 19. To this end, a current value applied to the coil 22 is set in such a manner that a speed difference between the cylindrical shaft 20a and the rotor shaft 2b is reduced to a level at which the inner circumferential face 20b of the cylindrical shaft 20a and the outer circumferential face 21 of the rotor shaft 2b are engaged to each other only by the magnetic force. Specifically, the brake 19 in which the cylindrical shaft 20a is fixed to the stationary member 20 is used as the engagement device. According to the embodiment, therefore, the current value applied to the coil 22 is set in such a manner that a rotational speed of the rotor shaft 2b is reduced to the level at which the inner circumferential face 20b and the outer circumferential face 21 are engaged to each other only by the magnetic force. Optionally, the current value applied to the coil 22 may be set in such a manner as to achieve a desirable upper limit torque of the brake 19. Then, it is determined at step S3 whether or not the polarity of the second permanent magnet 24 is reversed.

Such determination at step S3 may be made based on the current value applied to the coil 22. Optionally, the determination at step S3 may also be made using a torque sensor. In this case, reverse of the polarity of the second permanent magnet 24 may be determined based on a detection signal of a brake torque. As described, the polarity of the second permanent magnet 24 is switched by applying current to the coil 22, and the switched polarity is maintained even after the current supply to the coil 22 is cut off. In a case that the polarity of the second permanent magnet 24 has been reversed so that the answer of step S3 is YES, therefore, the current supply to the coil 22 is cut off at step S4. Consequently, directions of the magnetic fluxes are reversed to circulate between the first permanent magnet 23 and the second permanent magnet 24 through the rotor shaft 2b so that the inner circumferential face 20b of the cylindrical shaft 20a and the outer circumferential face 21 of the rotor shaft 2b are magnetically attracted to each other. By contrast, if the polarity of the second permanent magnet 24 has not yet been reversed so that the answer of step S3 is NO, the current supply to the coil 22 is continued until the polarity of the second permanent magnet 24 is reversed.

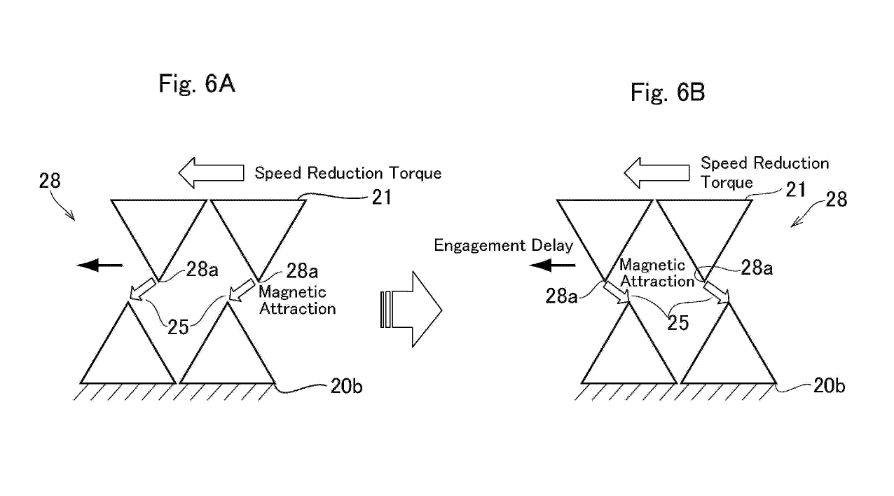

Then, at step S5, a speed of the rotor shaft 2b of the first motor 2 is synchronized to a speed of the cylindrical shaft 20a. Specifically, a speed difference between the rotor shaft 2b of the first motor 2 and the cylindrical shaft 20a is reduced to a predetermined value. That is, according to the embodiment, a speed of the rotor shaft 2b of the first motor 2 is reduced to stop the rotation of the rotor shaft 2b. In this situation, the rotor shaft 2b of the first motor 2 is subjected not only to a speed reduction torque but also to the magnetic attraction as shown in FIGS. 6A and 6B. For this reason, when the rotational speed of the rotor shaft 2b is reduced to a certain level, engagement of the brake 19 may be delayed as shown in FIG. 6B, if the speed reduction torque applied to the rotor shaft 2b is excessive. In order to avoid such delay in engagement of the brake 19, according to the embodiment, the ECU 29 is configured to stop the speed reduction (i.e., synchronization) of the first motor 2 when the speed difference between the rotor shaft 2b of the first motor 2 and the cylindrical shaft 20a is reduced to a threshold level.

Specifically, at step S6, it is determined whether or not the speed difference between the rotor shaft 2b of the first motor 2 and the cylindrical shaft 20a has been reduced to a first threshold level α, that is, the rotational speed of the rotor shaft 2b of the first motor 2 has been reduced to the first threshold level α. In other words, it is determined whether or not the inner circumferential face 20b of the cylindrical shaft 20a and the outer circumferential face 21 of the rotor shaft 2b may be engaged to each other only by the magnetic force. To this end, the first threshold level α is set to a level at which the inner circumferential face 20b and the outer circumferential face 21 may be engaged to each other only by the magnetic force. Optionally, since the speed of the rotor shaft 2b may cross the first threshold level α easily in response to a slight change in the speed of the first motor 2, the threshold level α may include a hysteresis.

If the rotational speed of the rotor shaft 2b of the first motor 2 is higher than the first threshold level α so that the answer of step S6 is NO, the routine returns to step S5 to continue the speed reduction of the first motor 2. By contrast, if the rotational speed of the rotor shaft 2b of the first motor 2 is lower than the first threshold level α so that the answer of step S6 is YES, the routine progresses to step S7 to reduce an output torque of the first motor 2 to zero. In other words, the speed reduction torque of the first motor 2 is reduced to zero.

Then, it is determined at step S8 whether or not the speed difference between the rotor shaft 2b of the first motor 2 and the cylindrical shaft 20a has been reduced to a second threshold level β, in other words, the rotational speed of the rotor shaft 2b of the first motor 2 has been reduced to the second threshold level β. That is, it is determined at step S8 whether or not the output torque of the first motor 2 has been reduced to zero to complete the engagement of the brake 19. To this end, the second threshold level β is set lower than the first threshold level α.

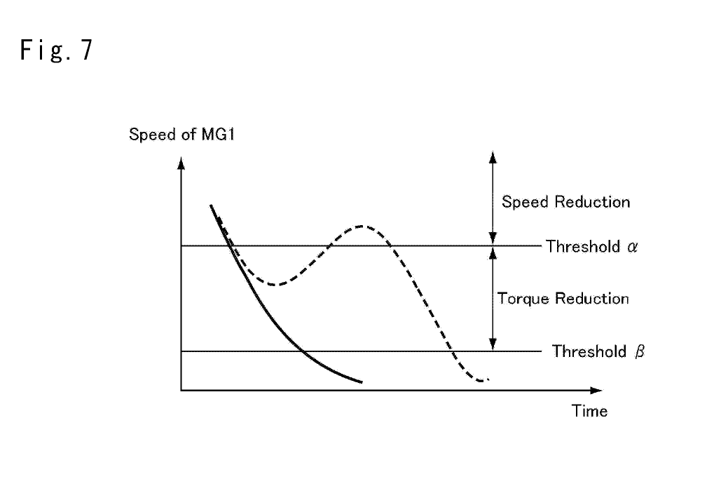

If the rotational speed of the rotor shaft 2b of the first motor 2 is higher than the second threshold level β so that the answer of step S8 is NO, the routine returns to step S6 to repeat steps S6 to S8. During the torque reduction between step S6 and S8, the rotational speed of the rotor shaft 2b of the first motor 2 may be fluctuated across the first threshold level α by disturbance such as abrupt braking, as indicated by a dashed curve in FIG. 7. In this case, the routine returns to step S6 to repeat steps S6 to S8. However, in a case that the rotational speed of the rotor shaft 2b of the first motor 2 falls between the second threshold level β and the first threshold level α so that the answer of step S8 is NO, the routine returns to step S6 but the answer of step S6 will be YES and the torque reduction at step S7 is continued until the rotational speed of the rotor shaft 2b is reduced lower than the second threshold level β. In FIG. 7, the solid curve indicates the rotational speed of the rotor shaft 2b of the first motor 2 that is reduced without being disturbed.

By contrast, if the rotational speed of the rotor shaft 2b of the first motor 2 is lower than the second threshold level β so that the answer of step S8 is YES, completion of engagement of the brake 19 is determined at step S9 and current supply to the first motor 2 is stopped at step S10.

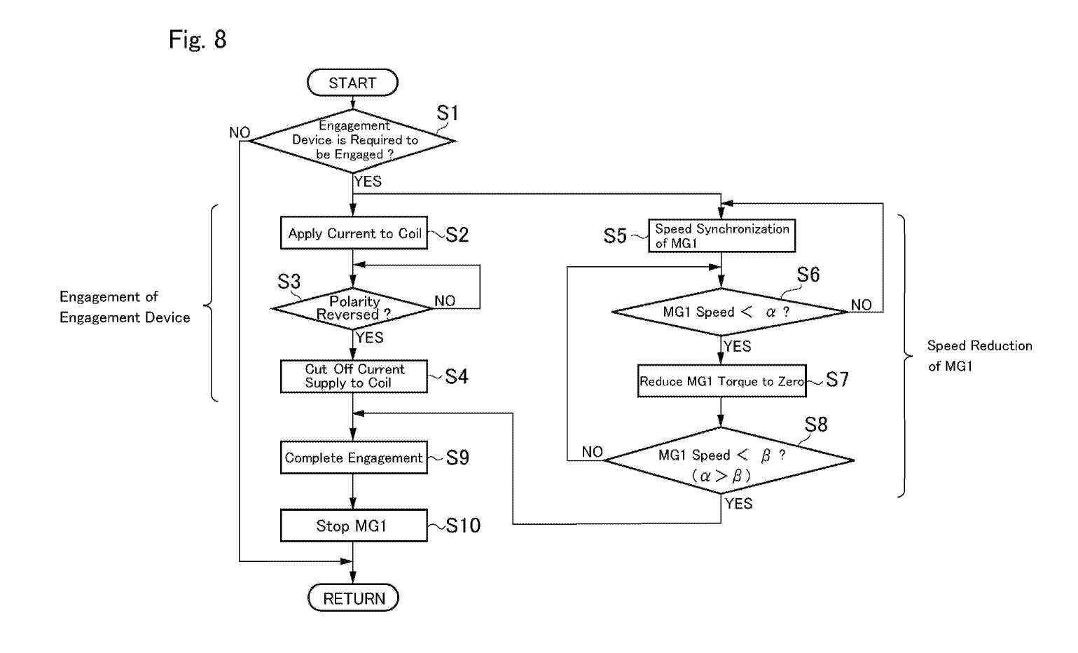

In the routine shown in FIG. 5, the brake 19 is commanded to be engaged first, and then the speed reduction of the first motor 2 is executed to shorten the amount of time required to the speed reduction of the first motor 2 in comparison with the conventional art. However, as shown in FIG. 8, the engagement of the brake 19 and the speed reduction of the first motor 2 may also be executed in parallel.

In this case, as shown in FIG. 8, the engagement of the brake 19 from step S1 to step S4 and the speed reduction of the first motor 2 from step S5 to step S8 are executed simultaneously. Then, the completion of the engagement of the brake 19 is determined at step S9, and the completion of the speed reduction of the first motor 2 determined at step S10.

Thus, according to the embodiment of the present disclosure, the required time of the speed reduction of the first motor 2 may be reduced and hence the operating point of the first motor 2 will not be shifted significantly. For this reason, a generating amount of the first motor 2 will not be changed significantly and a power loss of the first motor 2 may be reduced. In addition, since the fluctuation in a generating amount of the first motor 2 is suppressed, electricity supplied to the second motor 3 may be stabilized. That is, power generation and power consumption may be balanced. Moreover, the required time of the speed reduction of the first motor 2 and the required time of the engagement of the brake 19 may be further reduced by executing the engagement of the brake 19 and the speed reduction of the first motor 2 simultaneously. For these reasons, the operating mode may be shifted promptly.

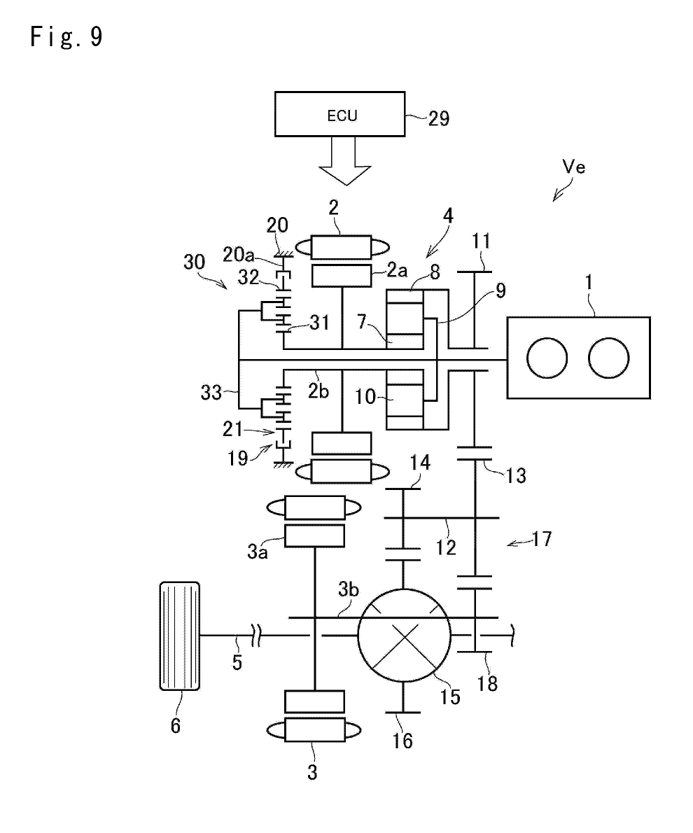

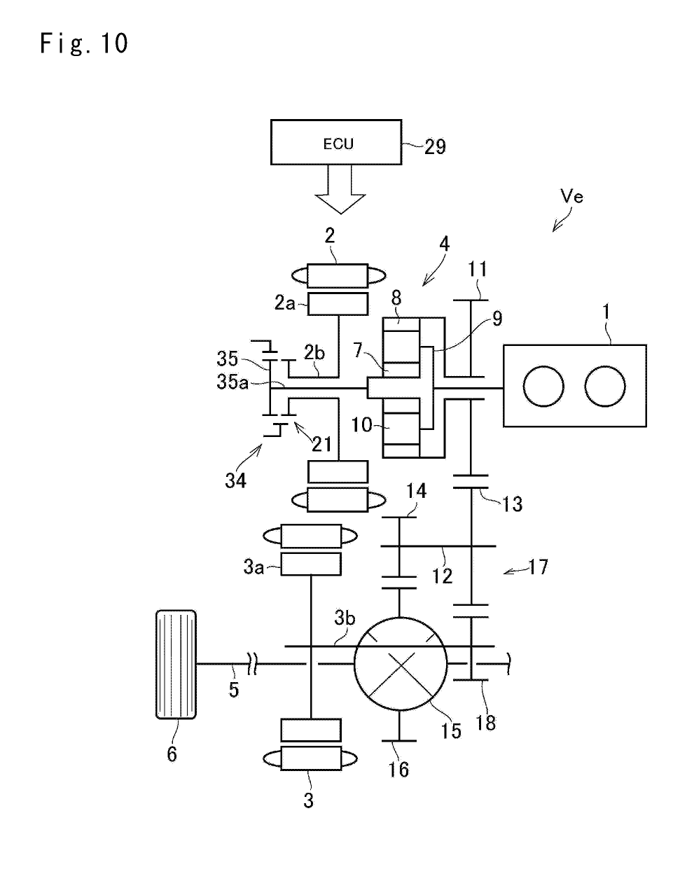

The control system according to the embodiment may also be applied to the vehicles shown in FIGS. 9 and 10. FIG. 9 shows a vehicle in which a rotation of an overdrive mechanism 30 is selectively stopped by the brake 19. Specifically, the overdrive mechanism 30 is a double-pinion planetary gear unit having a sun gear 31 as a sixth rotary element, a carrier 33 as a fifth rotary element, and a ring gear 32 as a fourth rotary element. The carrier 33 of the overdrive mechanism 30 is connected to the carrier 9 as the second rotary element of the power split device 4 as a first differential mechanism so that an output torque of the engine 1 is applied to the carrier 33 and the carrier 9. The sun gear 31 of the overdrive mechanism 30 is connected to the sun gear 7 as the first rotary element of the power split device 4 so that an output torque of the first motor 2 is applied to the sun gear 31 and the sun gear 7. The brake 19 is interposed between the ring gear 32 and the stationary member 20 to restrict a rotation of the ring gear 32 thereby establishing the overdrive mode. In the power split device 4, the ring gear 8 serves as the third rotary element, the overdrive mechanism 30 serves as a second differential mechanism of the vehicle Ve shown in FIG. 9. The remaining structures are similar to those of the vehicle Ve shown in FIG. 1, and detailed explanations for the common elements will be omitted by allotting common reference numerals thereto.

In the vehicle Ve shown in FIG. 9, an overdrive mode may be established during forward propulsion by the engine 1 or by the engine 1 and the second motor 3 while restricting a forward rotation of the ring gear 32 by the brake 19. In this situation, in the overdrive mechanism 30, a torque is applied to the carrier 33 in the forward direction while restricting the forward rotation of the ring gear 32 and hence the sun gear 31 is rotated in the counter direction. Meanwhile, in the power split device 4, the sun gear 7 is also rotated in the counter direction together with the sun gear 31 of the overdrive mechanism 30. In this situation, since the output torque of the engine 1 is applied to the carrier 9 of the power split device 4 while rotating the sun gear 7 in the counter direction, the ring gear 8 as the output element is rotated at a speed higher than the rotational speed of the carrier 9 (or the engine 1) to establish the overdrive mode. The output torque of the second motor 3 may also be added to the torque delivered to the drive wheels 6 through the differential gear unit 15. In the overdrive mode, since the first motor 2 is halted together with the ring gear 32 while stopping a power supply thereto, fuel efficiency at a high speed range may also be improved.

In the vehicle Ve, as shown in FIG. 10, a clutch 34 may also be used as the variable field engagement device instead of the brake 19. The clutch 34 is adapted to selectively connect and disconnect the rotor shaft 2b as the first engagement element of the first motor 2 to/from a rotary member 35 as a second engagement element connected to the sun gear 7. Specifically, the clutch 34 is brought into disengagement by rotating the rotor shaft 2b and the rotary member 35 relatively to each other, and the clutch 34 is brought into engagement by integrating the rotor shaft 2b with the rotary member 35 in the rotational direction. The remaining structures are similar to those of the vehicle Ve shown in FIG. 1, and detailed explanations for the common elements will be omitted by allotting common reference numerals thereto. In the vehicle shown in FIG. 10, for example, the routines shown in FIGS. 5 and 8 may be executed when shifting the operating mode from single-motor mode in which the vehicle Ve is powered only by the second motor 3 while disconnecting the first motor to the HV mode.

Although the above exemplary embodiments of the present application have been described, it will be understood by those skilled in the art that the present application should not be limited to the described exemplary embodiments, and various changes and modifications can be made within the spirit and scope of the present disclosure.

What is claimed is:

1. A control system for an engagement device, comprising:
a first engagement element and a second engagement element allowed to rotate relatively to each other;
a first motor that applies torque to the first engagement element to synchronize a rotational speed of the first engagement element to a rotational speed of the second engagement element;
a magnetic force generating member that is arranged in one of the first engagement element and the second engagement element to generate magnetic attraction to integrate the first engagement element with the second engagement element in a rotational direction while keeping a gap therebetween,
the control system comprising a controller that is configured to:
selectively engage the first engagement element with the second engagement element by selectively generating the magnetic attraction by the magnetic force generating member; and
start controlling the first motor in such a manner as to synchronize a rotational speed of the first engagement element to a rotational speed of the second engagement element, simultaneously with a commencement of engagement of the first engagement element with the second engagement element, or after the commencement of the engagement of the first engagement element with the second engagement element.

2. The control system for an engagement device as claimed in claim 1, wherein
the first engagement element includes an outer circumferential face,
the second engagement element includes an inner circumferential face opposed to the outer circumferential face of the first engagement element,
a plurality of protrusions are formed on the outer circumferential face of the first engagement element in such a manner as to protrude toward the inner circumferential face of the second engagement element, and
a plurality of protrusions are formed on the inner circumferential face of the second engagement element in such a manner as to protrude toward the outer circumferential face of the first engagement element.

3. The control system for an engagement device as claimed in claim 1, wherein
the magnetic force generating member includes a first permanent magnet and a second permanent magnet arranged in the second engagement element,
a polarity of the second permanent magnet is set in such a manner as to establish a closed magnetic circuit within the second engagement element between the first permanent magnet and the second permanent magnet,
the magnetic force generating member further includes a switching member that is arranged around the second permanent magnet to switch the polarity of the second permanent magnet,
the first engagement element is formed of magnetic material at least partially to be magnetically attracted toward the second engagement element,
the controller is further configured to
disengage the first engagement element from the second engagement element by controlling the switching member to establish the closed magnetic circuit within the second engagement element, and
engage the first engagement element with the second engagement element by controlling the switching member to generate the magnetic attraction between first engagement element and the second engagement element.

4. The control system for an engagement device as claimed in claim 3,
wherein the switching member includes a coil wound around the second permanent magnet, and
wherein the polarity of the second permanent magnet is reversed by applying current to the coil.

5. The control system for an engagement device as claimed in claim 1, wherein the controller is further configured to reduce an output torque of the first motor to zero, if a difference between a rotational speed of the first engagement element and a rotational speed of the second engagement element is smaller than a first threshold value during the synchronization of the rotational speed of the first engagement element to the rotational speed of the second engagement element.

6. The control system for an engagement device as claimed in claim 5, wherein the controller is further configured to determine completion of engagement of the first engagement element with the second engagement element, when a difference between the rotational speed of the first engagement element and the rotational speed of the second engagement element is reduced smaller than a second threshold value by reducing the output torque of the first motor to zero during the synchronization of the rotational speed of the first engagement element to the rotational speed of the second engagement element.

7. The control system for an engagement device as claimed in claim 1, wherein
the engagement element is applied to a vehicle in which a prime mover includes the engine, the first motor, and a second motor,
the vehicle includes a differential mechanism that performs a differential action among a first rotary element, a second rotary element, and a third rotary element,
the first motor is connected to the first rotary element, the engine is connected to the second rotary element, and an output member is connected to the third rotary element to deliver torque to drive wheels,
the second motor is connected to a power transmission route between the drive wheels and the third rotary element, and
the second motor is operated by electricity generated by the first motor to generate torque delivered to the drive wheels.

8. The control system for an engagement device as claimed in claim 7, wherein the differential mechanism includes:
a first differential mechanism that performs a differential action among the first rotary element, the second rotary element, and the third rotary element; and
a second differential mechanism that performs a differential action among a fourth rotary element, a fifth rotary element connected to the engine, and a sixth rotary element connected to the first motor.
